(19) United States
(12) Patent Application Publication
(10) Pub. No.: US 2014/0376558 A1
(43) Pub. Date: Dec. 25, 2014

(54) Dynamic Network Service Association and On Demand Service Provisioning

(71) Applicants: Prashant R. Rao, Oak Park, CA (US); Anthony Chow, San Gabriel, CA (US); Surajit Bhattacharya, Oak Park, CA (US)

(72) Inventors: Prashant R. Rao, Oak Park, CA (US); Anthony Chow, San Gabriel, CA (US); Surajit Bhattacharya, Oak Park, CA (US)

(73) Assignee: ALCATEL-LUCENT USA INC., Murray Hill, NJ (US)

(21) Appl. No.: 13/921,442

(22) Filed: Jun. 19, 2013

(51) Int. Cl. H04L 12/851; H04L 12/931

(52) U.S. Cl. CPC H04L 47/2441; H04L 49/351
USPC 370/401

(57) ABSTRACT

An edge switch enables service provisioning and dynamic service association for end devices coupled to the edge switch. The edge switch maintains a generic user profile that includes classification rules for classifying incoming traffic from the end devices to Virtual Local Area Network (VLAN) VLAN tunnel services. Upon detecting incoming traffic on an access port of the edge switch, the edge switch accesses the generic user profile to determine whether the incoming traffic matches one of the classification rules, and if so, automatically associates the incoming traffic with a VLAN tunnel service indicated by the matching classification rule to provide tunnel-based connectivity to remote end devices associated with the VLAN tunnel service.

### CROSS-REFERENCE TO RELATED PATENTS

Not Applicable.

### STATEMENT REGARDING FEDERALLY SPONSORED RESEARCH OR DEVELOPMENT

Not Applicable.

### INCORPORATION-BY-REFERENCE OF MATERIAL SUBMITTED ON A COMPACT DISC

Not applicable.

### BACKGROUND

1. Technical Field of the Invention

This invention relates generally to data networks and in particular to service provisioning and service association within data networks.

2. Description of Related Art

Data networks allow many different computing devices, for example, personal computers, IP telephony devices or servers to communicate with each other and/or with various other network elements or remote servers attached to the network. For example, data networks may include, without limitation, Metro Ethernet or Enterprise Ethernet networks that support multiple applications including, for example, voice-over-IP (VoIP), data and video applications. Such networks regularly include many interconnected nodes, commonly known as switches or routers, for routing traffic through the network.

The various nodes are often distinguished based on their location within particular areas of the network, commonly characterizing two or three “tiers” or “layers,” depending on the size of the network. Conventionally, a three tier network consists of an edge layer, an aggregation layer and a core layer (whereas a two tier network consists of only an edge layer and core layer). The edge layer of data networks includes edge (also called access) networks that typically provide connectivity from an Enterprise network or home network, such as a local area network, to a metro or core network. The edge/access layer is the entry point of the network, i.e., to which the customer network is nominally attached, and the switches residing at the edge layer are known as edge switches. Different types of edge networks include digital subscriber line, hybrid fiber coax (HFC), fiber to the home, and enterprise networks, such as campus and data center networks. Edge switches may perform, for example, L2 switching functions for the attached devices. The edge switches are generally connected to one or more Enterprise switches, Enterprise servers and/or other end devices in the customer network, and may also be connected to an aggregate layer that terminates access links coming from multiple edge switches. Switches residing at the aggregation layer are known as Aggregation Switches. Aggregation Switches may perform, for example, L2 switching and L3 routing of traffic received via the aggregate links from the edge switches. The aggregate layer (in a “three tiered” network) or the edge layer (in a “two tiered” network) is connected to a metro or core network layer that performs Layer 3/IP routing of traffic received from the Aggregation Switches or from edge switches. As will be appreciated, switches at each incremental layer of the network typically have larger capacity and faster throughput.

Virtual Local Area Network (VLAN) technology has allowed Enterprise networks to extend their reach across the core network to enable a LAN to be partitioned based on functional requirements, while maintaining connectivity across all devices on the LAN. In order for VLAN's to forward data to the correct destination, a tunneling protocol, such as Shortest Path Bridging (SPB), Virtual Private LAN Service (VPLS), Layer 3 Virtual Private Networks (L3VPN) or other tunneling protocol, is typically enabled in the core network to provide efficient connectivity between end devices in the network. At the edge network, end users/devices are classified to various VLAN tunnel services to provide the service distribution between the edge switches. For example, end users/devices that belong to a common entity/organization, and hence a common VLAN, can be classified to a unique VLAN tunnel service for that VLAN.

The act of associating incoming customer traffic on a user/access port of an edge switch with a particular VLAN tunnel service is commonly referred to as service association. The resulting association between customer traffic and a VLAN tunnel service is commonly referred to as a Service Access Point (SAP). Before service association can occur, the VLAN tunnel service must first be configured on the edge switches in the data network in a process known as service provisioning. For example, when using the SPB tunneling protocol, service provisioning on an edge switch typically involves defining the Extended Service ID (I-SID) and Backbone VLAN (BVLAN) of the SPB VLAN tunnel service on the edge switch. The I-SID binds one or more VLANs to a BVLAN. The BVLAN is identified by a particular BVLAN tag ID that is used by the backbone (or core) network to provide tunnel connectivity between edge switches.

Traditionally, both service provisioning and service association have been performed manually by a network administrator. Thus, the network administrator must know ahead of time the type of packets (VLANs) that will appear on a particular access port of the edge switch and configure the appropriate SAPs on that access port. If a particular packet arrives on an access port for which the appropriate SAP has not been configured, the edge switch will discard that particular packet. This may result in wasted network resources if more SAPs are configured on a particular access port than need to be. For example, if the network administrator anticipates that there may be ten different types of VLAN tag traffic that will appear on a particular access port, but at any given time, only two streams of traffic are coming into the particular access port, there will be eight SAP's sitting in an IDLE state on the access port. Moreover, end users/devices cannot conveniently move between access ports on the same edge switch or different edge switches since administrator intervention would be required each time an end user/device moves. Manually configuring edge switches based on the current location of an end user/device requires extensive labor and time, thus increasing the cost of managing VLAN's.

BRIEF DESCRIPTION OF THE SEVERAL VIEWS OF THE DRAWINGS

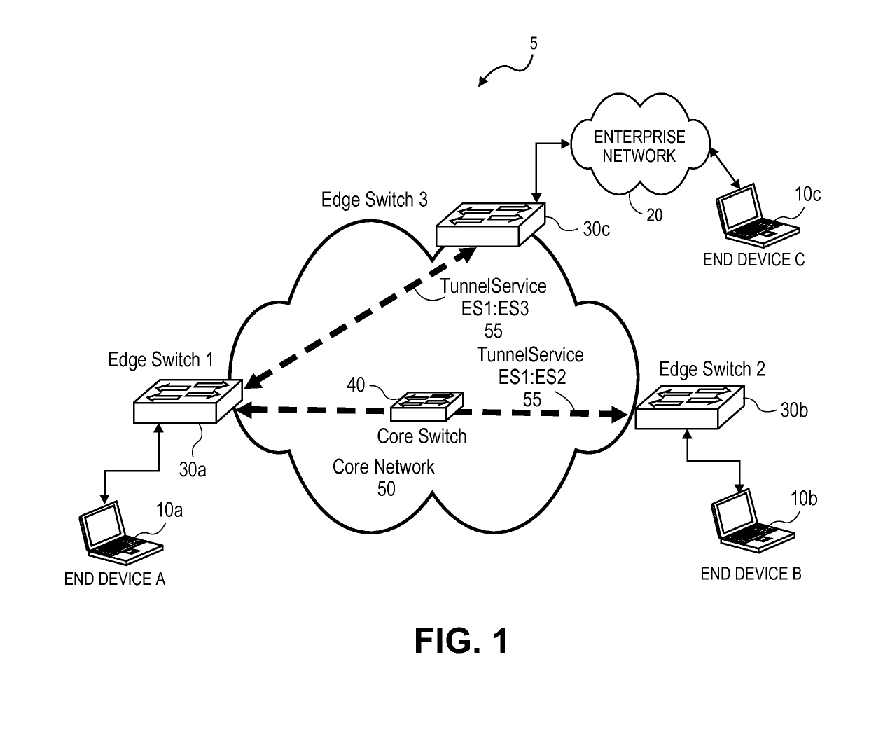

FIG. 1 illustrates a schematic block diagram of an embodiment of a service network;

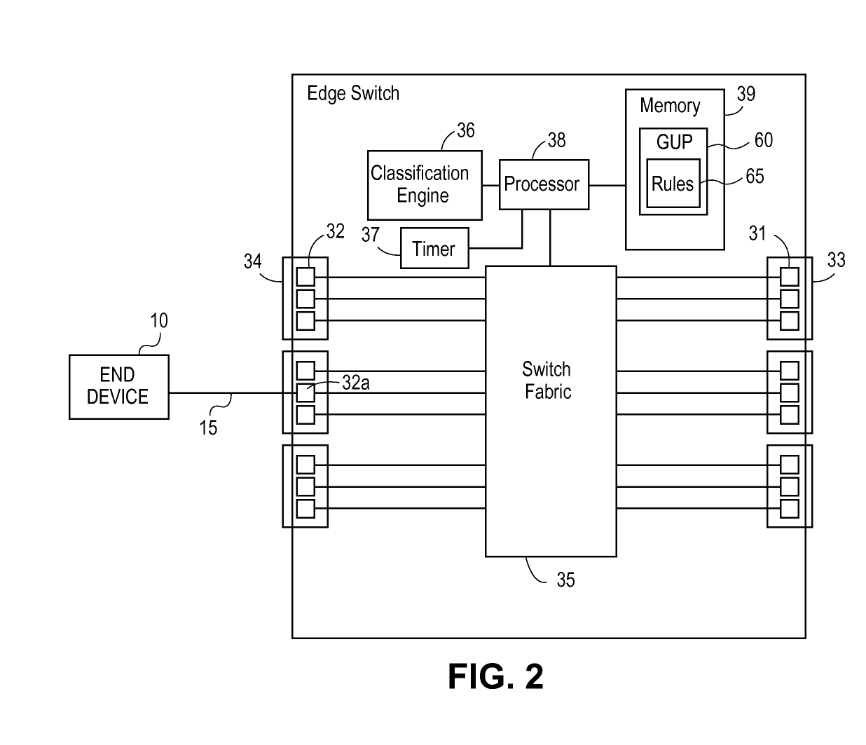

FIG. 2 illustrates a schematic block diagram of an embodiment of an edge switch within the service network;

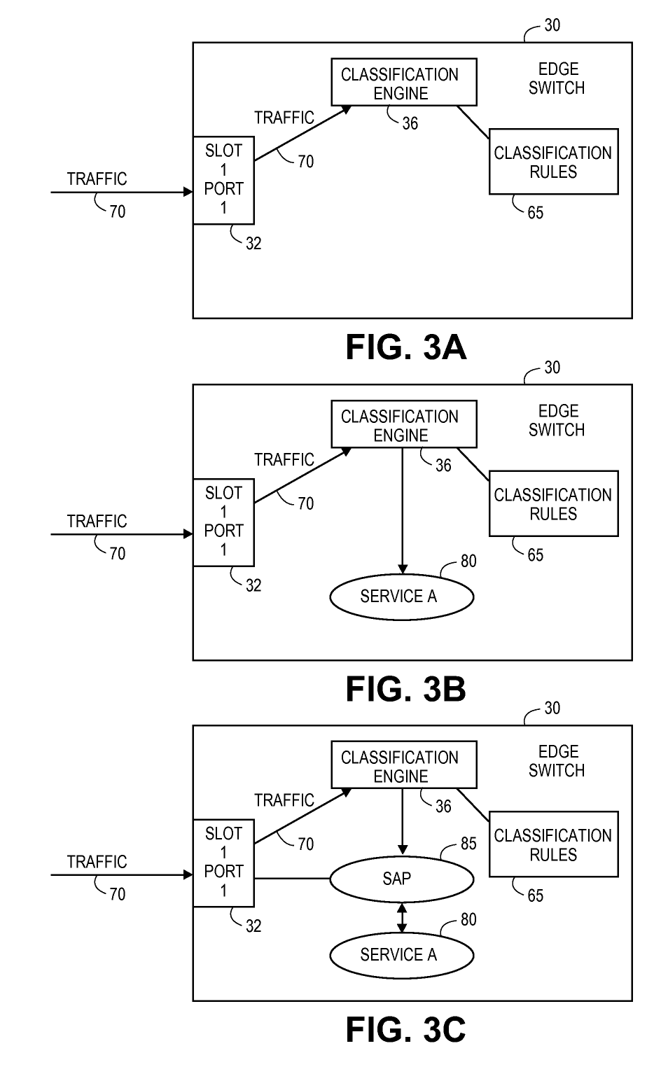

FIGS. 3A-3C illustrates an embodiment of an on demand service provisioning on an edge switch;

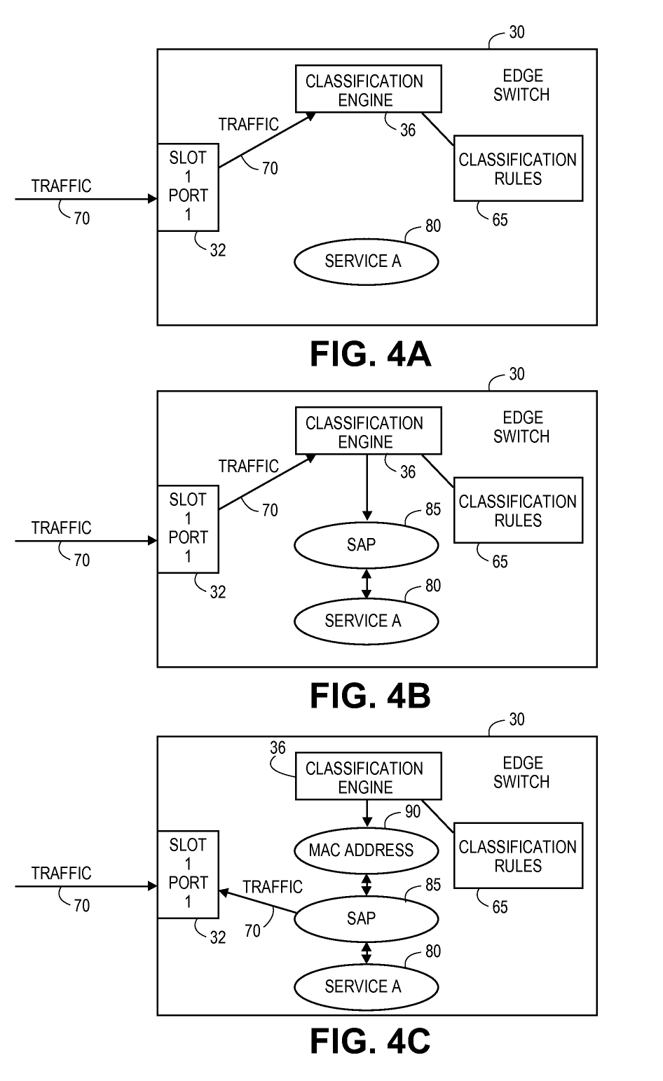

FIGS. 4A-4C illustrate an embodiment of a dynamic service association on an edge switch;

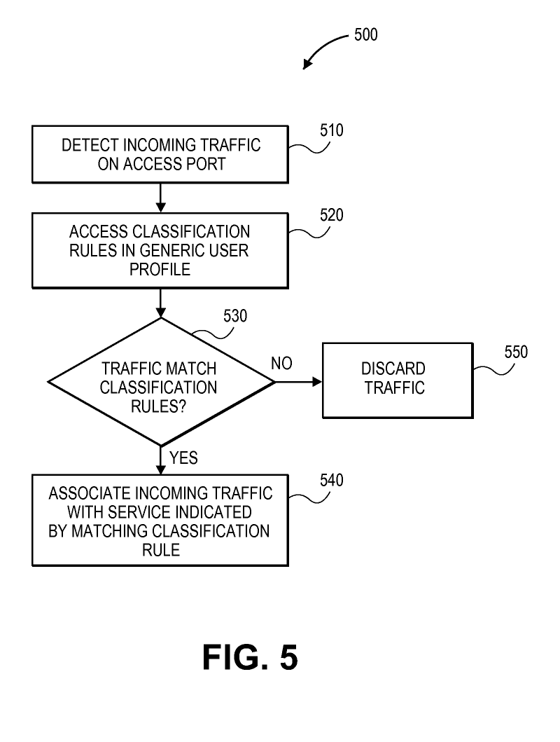

FIG. 5 illustrates an exemplary flow diagram of a method for dynamic service association on an edge switch;

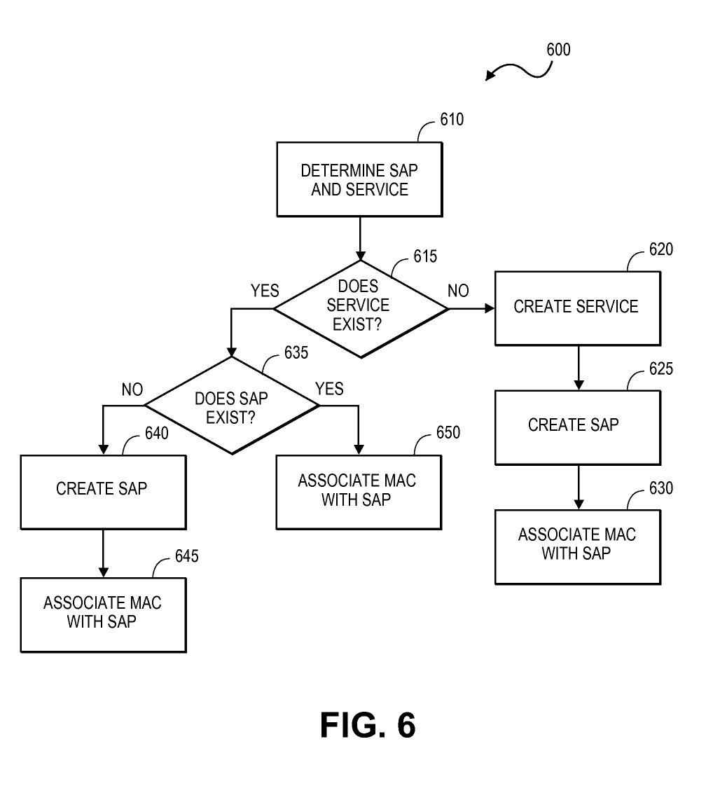

FIG. 6 illustrates an exemplary flow diagram for service provisioning and service association on an edge switch; and

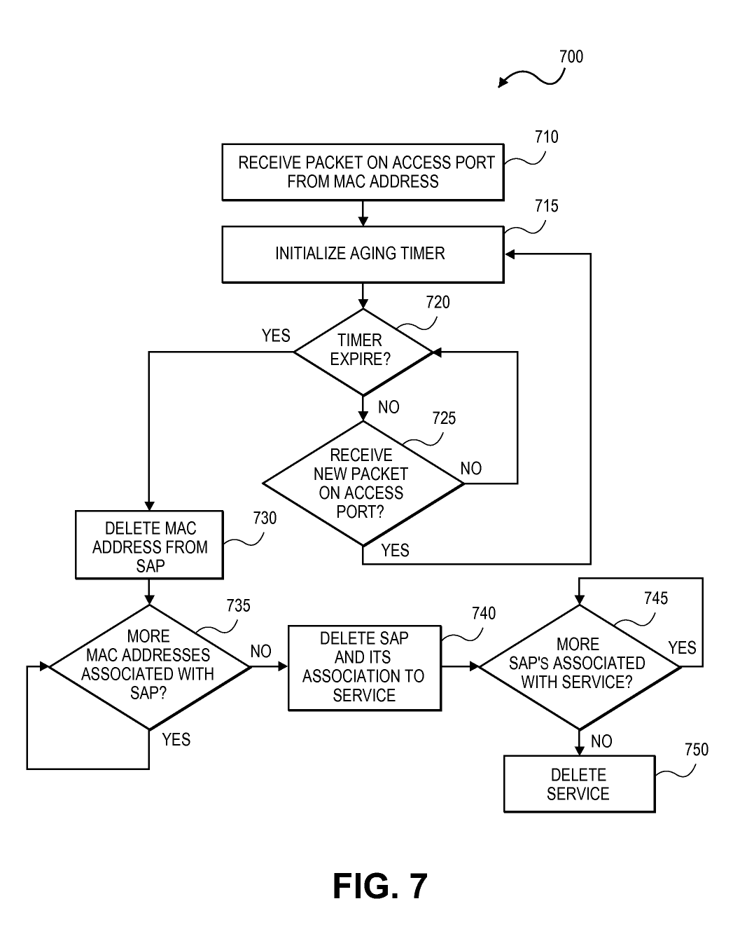

FIG. 7 illustrates an exemplary flow diagram for deleting a VLAN tunnel service on an edge switch.

### DETAILED DESCRIPTION OF THE INVENTION

FIG. 1 illustrates an embodiment of a service network 5, such as a Metro or Enterprise Ethernet network, that provides Virtual Local Area Network (VLAN) VLAN tunnel services between network devices. The service network 5 shown in FIG. 1 represents a “two tiered” data network, including an edge layer and a core layer. However, it should be noted that the service network may include additional layers, such as an aggregation layer.

The edge layer includes edge switches 30a-30c that provide connectivity from end devices 10a-10c within an Enterprise network 20 to the core network 50. The edge switches 30a-30c may perform, for example, L2 switching functions for the end devices 10a-10c. The end devices 10a-10c may include, for example, one or more Enterprise switches, Enterprise servers and/or other customer/end devices in the Enterprise network. The core network layer includes a plurality of core switches 40 (only one of which is shown for convenience) that perform Layer 3/IP routing of traffic received from the edge switches 30a-30c.

Each of the end devices 10a-10c may be associated with a particular Virtual Local Area Network (VLAN) of the Enterprise network 20. Data is communicated between the end devices 10a-10c within the same VLAN using a tunneling protocol, such as Shortest Path Bridging (SPB), Virtual Private LAN Service (VPLS), Layer 3 Virtual Private Networks (L3VPN) or other tunneling protocol. Within the edge switches 30a-30c, end devices 10a-10c are classified to a unique VLAN tunnel service to provide tunnel-connectivity between the end devices 10a-10c via the core network 50. For example, as shown in FIG. 1, End Devices A, B and C are all within the same VLAN. To enable End Device A to communicate with End Devices B and C, a VLAN tunnel service 55 is set up between Edge Switch 1 and Edge Switches 2 and 3.

In accordance with various embodiments, the VLAN tunnel service 55 can be created and removed on-demand. For example, service provisioning of the VLAN tunnel service 55 on Edge Switch 1 can be triggered by incoming traffic received from End Device A. As another example, service removal of the VLAN tunnel service 55 on Edge Switch 1 can be triggered by not receiving any incoming traffic from End Device A for a predetermined period of time. In addition, the service association between End Device A and the VLAN tunnel service 55 can be dynamically created on Edge Switch 1 based on the incoming traffic.

FIG. 2 illustrates an exemplary edge switch 30 within the service network. The edge switch 30 includes a plurality of access slots 34, each including a plurality of access ports 32, and a plurality of network slots 33, each including a plurality of network ports 31. The edge switch 30 is coupled to an end device 10 via a physical link 15 (e.g., an Ethernet link), which terminates at a particular access port 32a on the edge switch 30. The edge switch 30 is further coupled to the service network (i.e., other core/edge switches) via one or more of the network ports 31.

The edge switch 30 further includes switch fabric 35, a classification engine 36, a timer 37, a processor 38 and a non-transitory memory device 39. The classification engine 36 includes an algorithm (or set of instructions) interpretable and executable by the processor 38 to cause the processor 38 to carry out operations for on-demand service provisioning and dynamic service association. The classification engine 36 may be stored, for example, in the non-transitory memory device 39 or another non-transitory memory device within edge switch 30.

As used herein, the term “processor” is generally understood to be a device that drives a general-purpose computer. By way of example, but not limitation, the “processor” 38 may include one or more of a microprocessor, microcontroller, central processing unit (CPU), Field Programmable Gate Array (FPGA), Application Specific Integrated Circuit (ASIC), or any other processing device. In addition, as used herein, the term “non-transitory memory device” is generally understood to include a device that is used to store data and/or programs for use in a general-purpose computer. By way of example, but not limitation, the “non-transitory memory device” 39 may include one or more of a data storage device, random access memory (RAM), read only memory (ROM), flash memory, compact disc, ZIP^{TM} drive, tape drive, database or other type of storage device or storage medium.

The classification engine 36 automates the service provisioning and service association for an end device 10 using user profile information maintained in a Generic User Profile (GUP) 60 within memory 39. The GUP 60 typically includes authentication/authorization information for use in authenticating and authorizing an end device access to the service network and various Quality of Service (QoS) policies for providing a particular QoS to incoming traffic from an end device.

In accordance with various embodiments, the GUP 60 is enhanced to include classification rules 65 to automate the service provisioning and service association. This provides the network administrator with the ability of auto-configuration of services, so that the end devices coupled to a particular edge switch 30 can seamlessly communicate with remote locations (remote end devices) of the tunneled network after authentication of the end devices for network access. Thus, the network administration is vastly simplified since there is no need to manually setup the end device (user) to service association or service creation/provisioning to enable the tunnel access to remote networks. To ensure that similar end users/devices (i.e., end devices within the same VLAN) attach to the same unique VLAN tunnel service, the network administrator provides a common set of user profile information (authentication/authorization, QoS policies and classification rules 65) on each edge switch within the service network.

Within the edge switch 30, the classification rules 65 are utilized by the classification engine 36 to create a VLAN tunnel service in situations where the service itself is not available and to determine which VLAN tunnel service a Service Association Point (SAP) should be associated with in situations where a SAP has not been created for a particular access port 32. The classification rules 65 enable incoming traffic on a particular access port (e.g., access port 32a) to be associated with a particular VLAN tunnel service using information in different layers of the OSI networking stack, such as the MAC address, IP address, TCP/UDP port, VLAN tag ID (if included) or a specific application (i.e., browser traffic).

For example, the classification engine 36 can extract information from incoming traffic arriving on port 32a from the end device 10 to determine the particular VLAN tunnel service to which the incoming traffic should be classified. If the VLAN tunnel service does not exist, the classification engine 36 can create the VLAN tunnel service on the edge switch 30, create a Service Association Point (SAP) for the access port 32a, associate the SAP with the VLAN tunnel service and attach the MAC address of the incoming traffic to the SAP to enable the end device 10 to gain access to the service network defined by the VLAN tunnel service via the SAP. The SAP is identified not only by the slot number and port number on which the incoming traffic is arriving, but also the VLAN ID associated with the incoming traffic.

In an exemplary embodiment, when the end device 10 is first detected on port 32a (e.g., by end device 10 sending traffic over link 15 to port 32a), the processor 38 executes the classification engine 36 to automatically (without administrator intervention) associate the end device 10 with a particular VLAN tunnel service. In embodiments in which the traffic is untagged (e.g., a VLAN tag identifier is not included in the data frames sent by end device 10), the processor 38 extracts the MAC address of end device 10 from the received data packets/frames, and applies authentication/classification rules defined in the GUP 60 to the MAC address of the end device 10 to determine the VLAN associated with the MAC address.

Once the MAC address of end device 10 is learned on port 32a as being associated with a particular VLAN, the classification engine 36 accesses the classification rules 65 to determine whether one of the classification rules 65 matches the incoming traffic (based on, for example, one or more of the VLAN ID, MAC address, IP address, Access Port, application, etc.). If so, the classification engine 36 associates the incoming traffic with a particular VLAN tunnel service indicated by the matching classification rule to provide tunnel-based connectivity between the end device 10 and remote end devices associated with the VLAN tunnel service via one of the network ports 31. For example, once a SAP has been created for the service matching the incoming traffic on port 32a and the MAC address of the end device originating the incoming traffic has been attached to the SAP, the incoming traffic can be switched via switch fabric 35 between port 32a and one of the network ports 31 to be transmitted via the VLAN tunnel service over the core network to the remote end devices associated with that VLAN.

The timer 37 may include, for example, a plurality of aging timers, such that one of the aging timers can be assigned to each end device coupled to an access port 32 of the edge switch. As an example, an aging timer 37 for port 32a can be initialized upon reception of incoming traffic from end device 10 and re-initialized upon reception of new incoming traffic from end device 10 such that when port 32a does not receive any incoming traffic from end device 10 for a predetermined time period as determined by the aging timer (i.e., upon expiration of the timer 37), the processor 38 can delete the MAC address of the end device 10 from the edge switch 30 and remove the association between the MAC address and the SAP. In further embodiments, upon expiration of the aging timer 37 for the end device 10 coupled to port 32a, the processor 38 may also delete the SAP and it's association to the VLAN tunnel service if other MAC addresses are not associated with the SAP, and may delete the VLAN tunnel service itself from the edge switch 30 if other SAP's are not associated with the VLAN tunnel service.

Referring now to both FIGS. 1 and 2, as can be seen in FIG. 1, End Devices A, B and C reside in remote ends of the service network. In an exemplary embodiment, the service network 5 is enabled for service provisioning, and therefore, a tunneling protocol (e.g. SPB) is running in the core network 50 to provide tunnel-based connectivity between Edge Switches 1, 2 and 3. If End Devices A, B and C belong to a common entity of the service network (i.e., the Finance Department), End Devices A, B and C need to have a VLAN tunnel service 55 provisioned between Edge Switches 1, 2 and 3 in order for End Devices A, B and C to communicate. Therefore, a network administrator can configure each of Edge Switches 1, 2 and 3 to setup the authentication of End Devices A, B and C, and classify the use as belonging to the Finance Department based on the authentication results.

A sample GUP 60 including sample classification rules 65 stored on Edge Switch 1 is shown below. The sample GUP 60 enables Edge Switch 1 to associate incoming traffic arriving on slot 1 port 1 (port 1/1) from End Device A.

gup port 1/1 authentication enabled

gup spb-profile Spb_profile home tag-value 20 I-SID 5000 bvlan 61

gup classification vlan-tag 21 spb-profile Spb_profile home

gup port 1/1 port-type spb-access

gup port 1/1 default-spb-profile Spb_profile home

gup port 1/1 mac-authentication pass-alternate spb-profile

As can be seen in the above GUP 60, the default VLAN tunnel service on port 1/1 is identified by I-SID=500 and BVLAN=61, and incoming traffic with a VLAN tag ID=21 on port 1/1 should be classified to the VLAN tunnel service with I-SID=500 and BVLAN=61. In addition, the GUP 60 further provides the classification engine 36 with the ability to use an alternate VLAN tunnel service upon authentication of the MAC address of End Device A. The alternate VLAN tunnel service may be determined, for example, by matching classification rules 65 associated with a different port on Edge Switch 1. As an example, the classification engine 36 can search the classification rules 65 for each port on Edge Switch 1 to match the VLAN ID to a particular VLAN tunnel service and then create the VLAN tunnel service on Edge Switch 1 (if not already created), create an SAP for that particular VLAN tunnel service on port 1/1 and attach the MAC address of End Device A to the SAP.

Referring again to FIG. 2, in another embodiment, the classification rules 65 can further include a domain/type field so that the same traffic pattern (i.e., traffic originating from the same end device/user) can configured to be associated with different VLAN tunnel services based on the domain/type (e.g., slot/access port) that the traffic is detected. Thus, the network administrator can specify which VLAN tunnel service a user can access based on where the user is trying to access the network.

For example, the GUP 60 can be defined to include classification rules 65 for two different VLAN tunnel service entities, denoted Service A and Service B. Service A provides a user access to all the servers in the enterprise network, while Service B has restricted access, and therefore prevents a user from accessing the Accounting or HR servers. In this example, the GUP 60 can include two classification rules 65 for an end device (i.e., laptop) with MAC address 00:00:00:00:00:01 as follows:

(1) In the “Office” domain, traffic should have access to Service A (I-SID=50000 and backbone VLAN 100); and

(2) In the “External” domain, traffic should have access to Service B (I-SID=60000 and backbone VLAN 200).

The domains may be distinguished based on the particular slot/port at which incoming traffic from the end device is received. For example, when the end device with MAC address 00:00:00:00:00:01 is trying to gain access from the office, traffic is coming into the edge switch 30 from slot 1 port 1, and when that same end device tries to gain access to the network from home, traffic is coming into slot 2 port 1 of the edge switch 30. Thus, the classification rules 65 can be defined such that all of the ports on slot 1 of the edge switch 30 are in the “Office” domain, while all ports on slot 2 of the edge switch 30 are in the “home” domain. Thus, the classification rules 65 can be defined such that when seen on the “Office” domain, traffic will be classified to access Service A, and when seen on the “External” domain, traffic will be classified to access Service B.

If the user using the laptop with MAC address 00:00:00:00:00:01 and VLAN ID 20 is plugged onto the network and is connected to slot 1 port 1 of the edge switch 30, when the classification engine 36 detects data traffic on slot 1 port 1, the classification engine 36 determines that this traffic stream should be classified to Service A and associated with SAP {1/1/20}. Likewise, if the user using the laptop with MAC address 00:00:00:00:00:01 and VLAN ID 20 is plugged onto the network and is connected to slot 2 port 1 of the edge switch 30, when the classification engine 36 detects data traffic on slot 2 port 1, the classification engine 36 determines that this traffic stream should be classified to Service B and associated with SAP {2/1/20}.

With the information that MAC 00:00:00:00:00:01 should be classified to Service A or Service B, there are three different scenarios that may apply:

(1) The Service (A or B) does not exist and the SAP ({1/1/20} or {2/1/20} does not exist on the edge switch.

(2) The Service (A or B) exists, but the SAP ({1/1/20} or {2/1/20} does not exist

(3) The Service (A or B) exists and the SAP ({1/1/20} or {2/1/20} exists.

Referring now to FIGS. 3A-3C, in the first scenario above, and assuming the end device is coupled to slot 1 port 1 (port 32), upon receiving incoming traffic 70 on port 32, the incoming traffic 70 is provided to classification engine 36 for on demand service provisioning. Initially, as shown in FIG. 3A, there is no SAP created on port 32. Therefore, the classification engine 36 extracts information in the incoming traffic 70 and compares the information to the classification rules 65 to determine that the incoming traffic 70 should be associated with Service A. The classification engine 36 then determines whether there is service as uniquely defined by I-SID=50000 and backbone VLAN=100 already existing on the edge switch 30. For example, Service A may have been previously manually created or dynamically created as a result of traffic on another port of the edge switch matching other classification rules.

If Service A does not already exist on the edge switch 30, as shown in FIG. 3B, the classification engine 36 automatically creates Service A 80. If Service A 80 already existed on the edge switch 30 or upon creation of Service A 80 on the edge switch 30, the classification engine 36 then automatically creates a SAP 85 identified by slot =1, port =1 and VLAN ID=20, as shown in FIG. 3C. The classification engine 36 further associates the SAP 85 with Service A 80 to associate the incoming traffic 70 with Service A 80.

Referring now to FIGS. 4A-4C, in the second scenario above, and again assuming the end device is coupled to slot 1 port 1 (port 32), upon receiving incoming traffic 70 on port 32, the incoming traffic 70 is provided to classification engine 36 for service association. Initially, as shown in FIG. 4A, there is no SAP created on port 32. Therefore, the classification engine 36 extracts information in the incoming traffic 70 and compares the information to the classification rules 65 to determine that the incoming traffic 70 should be associated with Service A. The classification engine 36 then determines whether there is service as uniquely defined by I-SID=50000 and backbone VLAN=100 already existing on the edge switch 30. For example, Service A may have been previously manually created or dynamically created as a result of traffic on another port of the edge switch matching other classification rules.

If Service A does exist, as shown in FIG. 4A, the classification engine 36 then automatically creates a SAP identified by slot =1, port =1 and VLAN ID=20, as shown in FIG. 4B. The classification engine 36 further associates the SAP with Service A to associate the incoming traffic 70 with Service A. In addition, as shown in FIG. 4C, the classification engine 36 attaches the MAC address 90 (e.g., MAC address 00:00:00:00:00:01) to the SAP 85. It should be understood that in the third scenario above, if Service A exists and the SAP exists, the MAC address 00:00:00:00:00:01 may already be attached to the SAP and the end device would be able to gain access to the network defined by Service A via SAP {1/1/20}, as normal.

FIG. 5 illustrates an exemplary method 500 for dynamic service association on an edge switch within a service network that is enabled for service provisioning. The edge switch maintains a generic user profile containing both authentication/QoS information and classification rules for classifying incoming traffic to a particular VLAN tunnel service. At 510, incoming traffic from an end device within an enterprise network coupled to the edge switch is detected on a particular access port of the edge switch.

At 520, a classification engine within the edge switch accesses the classification rules within the generic user profile, and at 530, compares information (e.g., MAC address, VLAN tag ID, IP address, Access Port, application, etc.) associated with the incoming traffic to determine whether the incoming traffic matches one of the classification rules. If so, at 540, the incoming traffic is associated with a particular VLAN tunnel service indicated by the matching classification rule to provide tunnel-based connectivity to other end devices via the service network. For example, a SAP for the access port is associated with the VLAN tunnel service and the MAC address of the end device is attached to the SAP. If not, at 550, the incoming traffic is discarded.

FIG. 6 illustrates an exemplary method 600 for on-demand service provisioning and dynamic service association on an edge switch within a service network that is enabled for service provisioning. At 610, upon receiving incoming traffic from an end device at a particular access port of the edge switch, a classification engine within the edge switch determines the VLAN tunnel service and SAP for the incoming traffic, as described in FIG. 5. At 615, a determination is made whether the VLAN tunnel service exists on the edge switch. If not, at 620-630, the VLAN tunnel service is created on the edge switch, a SAP is created on the edge switch to associate the incoming traffic on the particular access port to the VLAN tunnel service and the MAC address of the end device that originated the incoming traffic on that particular access port is associated with the SAP.

If the VLAN tunnel service does exist on the edge switch, at 635, a determination is made whether the SAP exists on the edge switch. If not, at 640-645, a SAP is created on the edge switch to associate the incoming traffic on the particular access port to the VLAN tunnel service and the MAC address of the end device that originated the incoming traffic on that particular access port is associated with the SAP. If the SAP does exist on the edge switch, at 650, the MAC address of the end device that originated the incoming traffic on that particular access port is associated with the SAP (if not already).

FIG. 7 illustrates an exemplary method 700 for deleting a VLAN tunnel service on an edge switch within a service network that is enabled for service provisioning. At 710, an incoming packet/frame is received on an access port of the edge switch from an end device with a particular MAC address. At 715, an aging timer is initialized upon reception of the incoming packet/frame. At 720, a determination is made whether the aging timer has expired, and if not, at 725, a determination is made whether another (new) incoming packet/frame has been received from the MAC address at that access port. If another packet/frame is received prior to expiration of the aging timer, the aging timer is re-initialized at 715.

If the aging timer expires before another packet/frame is received from the MAC address on the access port, at 730, the MAC address is deleted from the SAP on the access port of the edge switch. At 735, a determination is then made whether there are additional MAC addresses associated with the SAP. If so, the SAP is maintained until all MAC addresses associated with the SAP have been deleted. Once there are no more MAC addresses associated with the SAP, at 740, the SAP and its association to the VLAN tunnel service are deleted from the edge switch. At 745, a determination is then made whether there are additional SAPs associated with the VLAN tunnel service. If so, the VLAN tunnel service is maintained on the edge switch until all SAPs associated with the VLAN tunnel service have been deleted. Once there are no more SAPs associated with the VLAN tunnel service, at 750, the VLAN tunnel service is deleted.

As may be used herein, the terms “substantially” and “approximately” provides an industry-accepted tolerance for its corresponding term and/or relativity between items. Such an industry-accepted tolerance ranges from less than one percent to fifty percent and corresponds to, but is not limited to, component values, integrated circuit process variations, temperature variations, rise and fall times, and/or thermal noise. Such relativity between items ranges from a difference of a few percent to magnitude differences. As may also be used herein, the term(s) “coupled to” and/or “coupling” and/or includes direct coupling between items and/or indirect coupling between items via an intervening item (e.g., an item includes, but is not limited to, a component, an element, a circuit, and/or a module) where, for indirect coupling, the intervening item does not modify the information of a signal but may adjust its current level, voltage level, and/or power level. As may further be used herein, inferred coupling (i.e., where one element is coupled to another element by inference) includes direct and indirect coupling between two items in the same manner as “coupled to”. As may be used herein, the term “operable to” indicates that an item includes one or more of processing modules, data, input(s), output(s), etc., to perform one or more of the described or necessary corresponding functions and may further include inferred coupling to one or more other items to perform the described or necessary corresponding functions. As may also be used herein, the term(s) “connected to” and/or “connecting” or “interconnecting” includes direct connection or link between nodes/devices and/or indirect connection between nodes/devices via an intervening item (e.g., an item includes, but is not limited to, a component, an element, a circuit, a module, a node, device, etc.). As may further be used herein, inferred connections (i.e., where one element is connected to another element by inference) includes direct and indirect connection between two items in the same manner as “connected to”.

Embodiments have also been described above with the aid of method steps illustrating the performance of specified functions and relationships thereof. The boundaries and sequence of these functional building blocks and method steps have been arbitrarily defined herein for convenience of description. Alternate boundaries and sequences can be defined so long as the specified functions and relationships are appropriately performed. Any such alternate boundaries or sequences are thus within the scope and spirit of the claimed invention. Similarly, flow diagram blocks may also have been arbitrarily defined herein to illustrate certain significant functionality. To the extent used, the flow diagram block boundaries and sequence could have been defined otherwise and still perform the certain significant functionality. Such alternate definitions of both functional building blocks and flow diagram blocks and sequences are thus within the scope and spirit of the claimed invention. One of average skill in the art will also recognize that the functional building blocks, and other illustrative blocks, modules and components herein, can be implemented as illustrated or by one or multiple discrete components, networks, systems, databases or processing modules executing appropriate software and the like or any combination thereof.

What is claimed is:

1. An edge switch, comprising:
an access port coupled to at least one end device;
a network port coupled to a core network;
a memory for storing a generic user profile, the generic user profile including classification rules for classifying traffic received on the access port to Virtual Local Area Network (VLAN) VLAN tunnel services; and
a processor for:
detecting incoming traffic on the access port;
accessing the generic user profile to determine whether the incoming traffic matches one of the classification rules; and
if the incoming traffic matches one of the classification rules, automatically associating the incoming traffic with a VLAN tunnel service indicated by a matching one of the classification rules to provide tunnel-based connectivity to remote end devices associated with the service via the network port.

2. The edge switch of claim 1, wherein the processor further:
determines a service identifier for the VLAN tunnel service from the incoming traffic;
determines whether the VLAN tunnel service exists on the edge switch based on the service identifier; and
if so, creates a service access point (SAP) for the access port, associates the SAP with the VLAN tunnel service and associates the incoming traffic with the SAP.

3. The edge switch of claim 2, wherein the SAP is identified by a slot number, an access port number and a VLAN identifier.

4. The edge switch of claim 2, wherein the processor further attaches a Media Access Control (MAC) address of an end device that originated the incoming traffic to the SAP to associate the incoming traffic with the SAP.

5. The edge switch of claim 4, further comprising:
an aging timer that is initialized upon reception of the incoming traffic from the end device and re-initialized upon reception of additional incoming traffic from the end device prior to the expiration of the aging timer.

6. The edge switch of claim 5, wherein the processor further:
deletes the MAC address of the end device from the SAP upon expiration of the aging timer.

7. The edge switch of claim 6, wherein, upon expiration of the aging timer, the processor further:
determines whether there are additional MAC addresses associated to the SAP; and
if not, deletes the SAP and the association of the SAP to the VLAN tunnel service.

8. The edge switch of claim 7, wherein, upon deletion of the SAP, the processor further:
determines whether there are additional SAPs associated with the VLAN tunnel service; and
if not, deletes the VLAN tunnel service.

9. The edge switch of claim 2, wherein if the service does not exist on the edge switch, the processor further creates the VLAN tunnel service on the switch.

10. The edge switch of claim 1, wherein the generic user profile further includes authentication information for use in authenticating the end device prior to the processor associating the incoming traffic to the VLAN tunnel service.

11. The edge switch of claim 1, wherein the tunnel-based connectivity is provided by a tunneling protocol.

12. The edge switch of claim 1, wherein the classification rules further include a domain field indicating a slot to which the VLAN tunnel service is associated.

13. The edge switch of claim 12, wherein the classification rules associate different VLAN tunnel services to different slots using the domain field.

14. A non-transitory memory device having tangibly embodied thereon and accessible therefrom a set of instructions interpretable by at least one processor, the set of instructions configured for causing the processor to carry out operations for:
detecting incoming traffic on an access port of an edge switch, the incoming traffic being originated by an end device coupled to the edge switch;
accessing a generic user profile including classification rules within the edge switch to determine whether the incoming traffic matches one of the classification rules; and
if the incoming traffic matches one of the classification rules, automatically associating the incoming traffic with a Virtual Local Area Network (VLAN) VLAN tunnel service indicated by a matching one of the classification rules to provide tunnel-based connectivity to remote end devices associated with the VLAN tunnel service.

15. The memory device of claim 14, wherein the associating the incoming traffic with the VLAN tunnel service further comprises:
determining a service identifier for the VLAN tunnel service from the incoming traffic;
determining whether the VLAN tunnel service exists on the edge switch based on the service identifier; and
if so:
creating a service access point (SAP) for the access port;
associating the SAP with the VLAN tunnel service; and
associating the incoming traffic with the SAP.

16. The memory device of claim 15, wherein the associating the incoming traffic with the SAP further comprises:
attaching a Media Access Control (MAC) address of the end device that originated the incoming traffic to the SAP to associate the incoming traffic with the SAP.

17. The memory device of claim 16, further comprising:
initializing an aging timer upon reception of the incoming traffic from the end device; and
re-initializing the aging timer upon reception of additional incoming traffic from the end device prior to the expiration of the aging timer.

18. The memory device of claim 17, further comprising:
upon expiration of the aging timer:
deleting the MAC address of the end device from the SAP upon expiration of the aging timer;
determining whether there are additional MAC addresses associated to the SAP;
if not, deleting the SAP and the association of the SAP to the VLAN tunnel service;
determining whether there are additional SAPs associated with the VLAN tunnel service; and
if not, deleting the VLAN tunnel service.

19. The memory device of claim 15, further comprising:
if the VLAN tunnel service does not exist on the edge switch, creating the VLAN tunnel service on the switch.

20. A method for dynamic service association, comprising:
detecting incoming traffic on an access port of an edge switch, the incoming traffic being originated by an end device coupled to the edge switch;
accessing a generic user profile including classification rules within the edge switch to determine whether the incoming traffic matches one of the classification rules; and
if the incoming traffic matches one of the classification rules, automatically associating the incoming traffic with a Virtual Local Area Network (VLAN) VLAN tunnel service indicated by a matching one of the classification rules to provide tunnel-based connectivity to remote end devices associated with the VLAN tunnel service.
